(19) United States
(12) Patent Application Publication
(10) Pub. No.: US 2020/0012579 A1
(43) Pub. Date: Jan. 9, 2020

(54) MONITORING AND MANAGEMENT SYSTEM OF OPERATIONAL AND PERFORMANCE PARAMETERS OF A CRYPTOCURRENCY MINING FARM

(71) Applicant: FACEMEN TC LLC, Urmarskij r-on (RU)

(72) Inventors: Aleksandr Nikolaevich ANOKHIN, p. Lesodolgorukovo (RU); Ivan Mikhailovich KUDRIASHOV, g. Cheboksary (RU); Leonid Olegovich PISKAREV, g. Cheboksary (RU); Aleksandr Sergeevich GUSAROV, g. Cheboksary (RU)

(21) Appl. No.: 16/445,652

(22) Filed: Jun. 19, 2019

(30) Foreign Application Priority Data
Jul. 3, 2018 (RU) 2018124334

(51) Int. Cl. G06F 11/30; G06Q 20/36; G06F 11/34; G06F 11/14

(52) U.S. Cl. CPC G06F 11/3062; G06F 11/1441; G06F 11/3452; G06Q 20/3672

(57) ABSTRACT

The present invention is a system intended to ensure the safe and efficient operation of cryptocurrency mining farm based on Bitcoin payment systems that in particular manages its functioning and the operational parameters of its equipment. The system comprises a power supply unit (PSU), a control microcomputer installed in the PSU, logging devices installed on hashboards across the farm miners that log working parameters for the farm, and a logging device to log the operational parameters of the farm that is installed in the PSU; the logging devices support data transfer to miners' microcomputers via a serial peripheral interface, an automatic power-off device is installed in the PSU. The decision-making module of the master is connected to the interface in order to perform emergency shutdown of the farm if its current working parameters differ from optimal.

### CROSS-REFERENCE TO RELATED APPLICATIONS

The present patent application claims priority to Russian patent application RU2018124334 filed Jul. 3, 2018.

### FIELD OF INVENTION

The given invention is a system intended to ensure the safe and efficient operation of cryptocurrency mining farm based on Bitcoin payment systems (hereinafter referred to as the “farm”) that in particular manages its functioning and the operational parameters of its equipment.

### BACKGROUND

Cryptocurrency mining farm comprises several miners, each of them is a computer device, which usually consists of motherboard, hash boards, microcomputer, PSU.

Some devices are intended to work as a web farm. They comprise software components that enable data synchronization, monitor if new data is available for the web farm, switch the web farm to preparation state if the new data is available, switch the web farm to modifications registration state if web farm's elements successfully receive the new data, and switch the web farm to termination state if any of its elements fails to receive the new data (Russian Patent No. 2314546 of Apr. 10, 2005).

However, these devices do not support logging of functional and operational parameters and their analysis, which is intended to prevent potential emergency situations if these parameters are not optimal for the farm.

### SUMMARY

This invention is aimed at creating a system that continuously monitors external and internal working parameters of a cryptocurrency mining farm including logging and analysis of its working conditions. That ensures faster response in order to prevent emergency situations and ultimately helps to avoid failures in the functioning of the farm.

The technical effect of the invention will be more reliable protection of the cryptocurrency mining farm against damage of the important working nodes in case of emergency situations and stable farm operation along with a sustainable performance level through the entire mining process.

The above technical effect is achieved by creating a control system that controls external and internal working parameters of a cryptocurrency mining farm (e.g. hashboard temperature, amount of current passing through the hashboards, ambient temperature and humidity) and comprises a power supply unit (PSU), controlling microcomputer (hereinafter referred to as “master”) installed in the PSU, logging sensors installed on hashboards across all farm miners that log working parameters of the farm, and a logging device installed in the PSU that logs the operational parameters for the farm (hereinafter referred to as the “logging devices”), and logging devices located on hashboards, which are executed with the ability to transfer data to miners' microcomputers via a serial peripheral interface.

It also includes an automatic power-off device installed in the PSU. Master device connects to miners' microcomputers via LAN to receive data from logging devices and statistical data from individual miners' microcomputers, as well as to the logging device installed in the PSU to receive data via wired connection. In addition, the master supports sending data about operational parameters and errors of the farm to the interface, and has a data receipt and collection module that ensures receipt and processing of statistical data regarding farm operation, its external and internal working parameters, which also support sending these current values to the interface to the master that will analyze the data and make decisions about further actions (the decision-making module of the master is connected to the interface in order to send the farm error data), an execution module connected to the decision making module that receives a signal from the decision-making module and sends the command to the master's microprocessor to perform an emergency shutdown of the farm if its real working parameters differ from optimal, and a launch module connected to the decision-making module that receives a signal from the decision-making module and supports sending the command to the master's microprocessor to save the state of the automatic power-off device and supply the power if the farm's parameters are within limits, an automatic power-off device is connected to the master's microprocessor (this microprocessor controls the automatic farm power-off device).

The system logs and controls the following working parameters for the mining farm: hashboard temperature, the amount of current consumed by the hashboards, and the farm's operational parameters: ambient temperature and humidity.

Appropriate sensors are used as logging devices to log internal and external operational parameters of the farm and its equipment.

In order to control the farm's operational parameters, temperature and current sensors are embedded into each miner's hashboards (an electronic computational device used to mine cryptocurrencies).

Besides, the system can detect via the data received from the logging devices whether the number of hashboards per miner or miners per chain has decreased. This is achieved by enabling logging devices to detect if specific hashboards are consuming any power. This allows to quickly conclude that a specific hashboard (or all hashboards) of the miner has failed and promptly restore functionality of the hashboard or miner, which in turn provides for sustainable and effective farm operation and prevents performance degradation by ensuring prompt repairs.

An ambient temperature and humidity sensor is installed in the PSU in order to control operational parameters of the equipment.

The master comprises a microprocessor with software installed. The master is software-operated and comprises the following modules: data receipt and collection module, decision-making module, execution module, launch module.

The master supports receiving data regarding the performance parameters of the farm's equipment from the logging device located in the PSU via wired connection, receiving data regarding operational parameters of the farm from the logging devices located in the miners, and receiving statistical data from the microcomputers of the farm's miners via LAN.

The system is designed to send data on the operational parameters from the logging devices installed on the hashboards of miners to the microcomputer of the appropriate miner.

Besides, the system uses the master to collect, process and analyze data regarding the farm's operational parameters received from the miners' microcomputers; data regarding operational parameters received from the logging devices located in the PSU and the following statistical data: hashboard errors (the percentage of incorrectly handled hashing operations), hashboard performance (hashrate—computation capacity, number of hashing operations per second). Statistical data is logged by the hashboard and motherboard microcontrollers in the microcomputer of each miner.

The master makes it possible to collect and process statistical data, farm's operational parameters received from the miners' microcomputers, and operational parameters received from the logging device located in the PSU. The master supports setting a timeframe for collection of statistical data for the farm's operational and performance parameters. Thus, the system ensures continuous monitoring. To achieve this, the master's data receipt and collection module receives data at set intervals from the miners that collect log data from the sensors and create statistical data, as well as from the sensor installed in the PSU and send it further to other modules of the master that analyze the data and make decisions.

The system can display the current operational parameters (ambient temperature and humidity) in the operator/user interface via the data receipt and collection module. The system interface can continuously display logged operational parameters that ensures prompt notification of the operator and enables the operator to continuously monitor and adjust operational parameters to keep them optimal. This makes it possible to avoid overheating and failing of the farm's equipment if the ambient temperature rises, as well as prevent damaging the equipment due to corrosion caused by long-term excessive ambient air humidity. Thus, the system achieves higher stability and helps protect important working nodes thanks to faster response in implementing steps to prevent emergency situations.

The master's decision-making module contains data regarding the farm's operational values (standard permissible parameters) that are optimal for its functioning and about the permissible hashboard error that is specified based on the optimal operation and performance parameters for the hashboards.

Decision-making module enables analysis of the statistical data: hashboard errors, hashboard performance, which is ensured by the decision-making module comparing the received data with the permissible hashboards errors specified based on the optimal operational parameters for the hashboards, optimal performance data for the hashboards upon receipt of the data relating to deviation of the current parameters from the set or permissible values for the farm operation (indicators of the farm error). Analysis output is sent to the interface. Farm errors are caused by hashboard failure and ultimately degrade the farm's performance. If the operator is able to monitor the farm error indicators, they can promptly react to the farm error and take measures to eliminate the error (e.g. promptly replace hashboards) to ensure sustainable farm operation and optimal level of farm performance through the entire mining process.

Besides, the decision-making module supports analysis of the farm's operational parameters by comparing the farm's current operational parameters received from the data receipt module with the permissible farm operational parameters and supports making a decision whether to change or leave the state of the automatic power-off device.

If the system detects that the data from the logging sensors is outside of the farm's normal operational parameters, it sends a shutdown signal via the decision-making module to the execution module.

The master thus supports management of the automatic farm power-off device based on the received data; for this purpose the execution module sends a farm shutdown command via the master's microprocessor to the automatic power-off device in case the logged operational parameters do not correspond with the optimal parameters.

Ability to implement continuous monitoring of the farm's operational parameters and perform automatic power-off of the farm if operational parameters differ from acceptable parameters for farm operation, ensures higher reliability in protecting the farm against damaging important working nodes in case of emergency.

The automatic farm power-off device is connected to the microprocessor of the master by wire.

Transistors, relays and other circuit opening/closing devices may be used as an automatic power-off device. The master may use low-voltage electrical signals to manage the automatic power-on/power-off device.

A switch may be used to establish connection and exchange data between the microcomputers of the master and the miners.

The PSU supplies power to the farm miners and is connected to them by wire.

### BRIEF DESCRIPTION OF THE DRAWINGS

The essence of the invention is illustrated in FIGS. 1, 2, which show:

FIG. 1 the general system operation pattern;

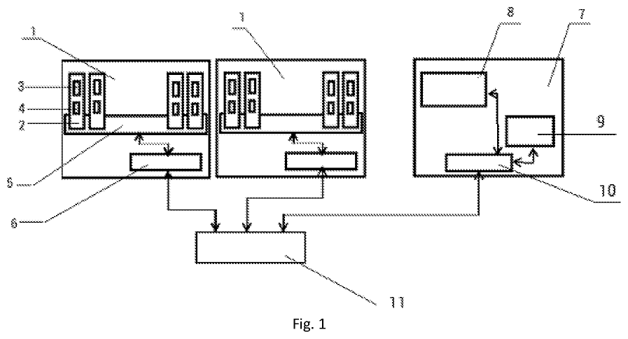

FIG. 2 the block diagram of operations sequence performed by the master's software that illustrates the general view of a sample data exchange between system devices and this farm in this version of the invention.

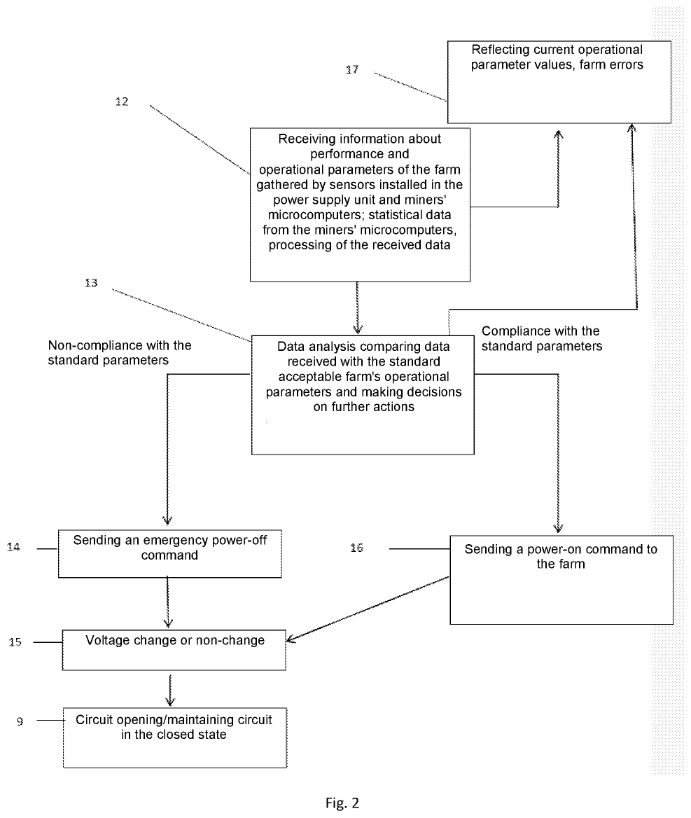

Items 1-17 on the figures have the following designations:
1—miner;
2—hashboard (in each miner);
3—temperature sensor (on each hashboard);
4—current sensor (on each hashboard);
5—motherboard (in each miner);
6—microcomputer (in each miner);
7—farm's PSU;
8—ambient temperature and humidity sensor;
9—IGBT transistor;
10—master;
11—switch;
12—data receipt and collection module,
13—decision-making module;
14—execution module;
15—microprocessor;
16—launch module;
17—interface.

### DETAILED DESCRIPTION OF THE PREFERRED EMBODIMENT

The system functions as follows.

The farm may comprise n miners of similar composition equipped with the same set of sensors.

Sensors 3 and 4 embedded into hashboards of 2 motherboards in 5 miners 1 continuously log the temperature and current consumption of the hashboards (farm operational parameters). Miners' microcomputers collect data from sensors 3 and 4. Every 10 seconds the data receipt and collection module of master 12 receives the data from the miners via LAN switch 11.

At the same time, sensor 8 located in the PSU 7 logs ambient temperature and humidity (operational parameters of the farm); every 10 seconds the data receipt and collection module 12 in master 10 receives this data by a wire connection.

Data receipt and collection module 12 of master 10 receives the following statistical data also with 10-second interval: farm performance and hashboard error data sent by microcomputers of 6 miners via LAN switch 11.

The data received by the data receipt module 12 in master 10 is processed, at the same time the data about operational parameters of the farm is sent to interface 17, and statistical data together with the operational parameters data is sent for analysis to the decision-making module 13. The decision-making module 13 of the master analyzes the data received by comparing the data received from the data receipt module 12 relating to the temperature and current consumption of the hashboards (farm operational parameters) with the standard permissible farm operational parameters saved in the decision-making module 13, and comparing farm performance data together with the hashboard error data with the saved permissible hashboard error data and preset optimal hashboard performance values. Statistical data analysis output, in particular, the computer farm error data, is sent to the interface. Based on the output of analysis of the operational parameters in decision-making module 13, a decision is made to change or not to change the state of IGBT transistor 9 via the execution module. In case the farm's operational parameters logged by the sensors are not within standard permissible parameters, the decision-making module 13 sends a farm shutdown signal to microprocessor 15 in master 10 via execution module 14. Microprocessor 15 changes the output voltage, it causes the IGBT transistor 9 located in PSU 7 to open the circuit, and that causes emergency power-off of the farm.

If after analyzing the data on the farm's operational parameters, the decision-making module 13 determines that the farm's operational parameters are acceptable, then the decision-making module sends a signal to launch module 16 to send the command to microprocessor 15 of master 10 (that controls IGBT transistor 9) to retain the IGBT transistor state (if powered on) and supply power to the miners via the IGBT transistor. And, upon receiving the command from launch module 16, microprocessor 15 maintains the previously set control voltage, IGBT transistor 9 does not open the circuit and the power supply for the farm is not interrupted (if the IGBT transistor is off, and the logged farm operational parameters are acceptable, the launch module sends a signal to change the output voltage to turn on the IGBT transistor to enable power supply for the miners).

Continuous monitoring of the farm's operational parameters and capability to perform automatic power-off if the farm's operational parameters fall out of the limits of set parameters, allow the system to provide better protection of the farm operation, and to prevent emergency situations thus ensuring efficient farm operation.

Monitoring the hashboard temperature helps prevent overheating of the hashboards and subsequent failure. Monitoring the hashboard power consumption helps prevent overheating of the hashboards in case of current consumption over the preset limit.

The embodiment also helps to achieve more reliable protection of farm against damaging of important working nodes by allowing faster response to prevent emergency situations resulting from mining under excessive humidity and temperature. Prompt response and expedient steps to prevent emergency situations become possible because the system continuously displays the current ambient temperature and humidity in the interface. Ambient temperature and humidity are of great importance for farm mining. Increasing ambient temperature may adversely affect the farm and may cause the farm equipment to overheat and thus fail. Humidity is also a factor for the farm because operating in increased humidity may lead the steel parts of electrical equipment corroding quickly which in turn results in the farm equipment wearing out and failing, and if a farm operates in decreased humidity, it may lead to overheating because decreased humidity results in decreased heat conductivity of air.

What is claimed is:

1. A system to control an external and internal operational parameters of a cryptocurrency mining farm, comprising:
a power supply unit (PSU), a control microcomputer installed in the PSU, miners' logging devices that log the external and internal operational parameters of the farm that are installed on hashboards across farm miners, and a first logging device to log the external and internal operational parameters of the farm which is installed in the PSU, wherein the miners' logging devices located on the hashboards support data transfer to the miners' microcomputers;
an automatic farm power-off device installed in the PSU, wherein the control microcomputer connects to the farm miners' microcomputers to receive data from (1) the miners' logging devices located on the hashboards and (2) statistical data from the miners' microcomputers and (3) the logging device located in the PSU that logs the farm's operational parameters; wherein
the control microcomputer supports transferring data on the farm operational parameters and farm error indicators to an interface;
the control microcomputer also comprises a data receiving and collecting module that enables receipt and processing of the statistical farm operational data, data on operational and performance parameters for the farm and supports sending current values of the farm operational parameters to the interface and the farm operation information and statistics to a decision-making module of the control microcomputer for purposes of conducting operational parameters and statistics analysis and making a decision on further actions;
wherein the decision-making module of the control microcomputer is connected to the interface in order to send the farm error indicators; an execution module connected to the decision-making module in order to receive a signal from the decision-making module, and send a command to a microprocessor of the control microcomputer to perform an emergency farm shutdown if its operational parameters are not within limits of the optimal parameters for this farm; and a launch module connected to the decision-making module in order to receive signal from the decision-making module, which supports sending a command to the microprocessor of the control microcomputer to retain an automatic power-off device state and
supply power if the farm operational parameters are within the limits of the standard acceptable parameters for this farm,
wherein an automatic farm power-off device is connected to the microprocessor of the control microcomputer and supports management of the automatic farm power-off device.
